(19) United States
(12) Patent Application Publication
(10) Pub. No.: US 2005/0197824 A1
(43) Pub. Date: Sep. 8, 2005

(54) Object-oriented design method for the time-effective and cost-effective development of production-grade embedded systems based on a standardized system architecture

(76) Inventor: Rokus H. J. Van Dalen, Nijkerk (NL)

Correspondence Address: KNOBBE MARTENS OLSON & BEAR LLP, 2040 MAIN STREET, FOURTEENTH FLOOR, IRVINE, CA, 92614, US

(21) Appl. No.: 11/062,311

(22) Filed: Feb. 17, 2005

Related U.S. Application Data
(63) Continuation of application No. PCT/EP03/09286, filed on Aug. 21, 2003.

(30) Foreign Application Priority Data
Aug. 21, 2002 (EP) 02447158.3

(51) Int. Cl. G06F 9/455

(52) U.S. Cl. 703/28

(57) ABSTRACT

The present invention relates to a system architecture for embedded systems based on hardware and software objects, in which the hardware objects are integrated with a hardware framework, and the software objects serve as software driver interface with the embedded application software for the hardware objects.

### CROSS REFERENCE TO RELATED APPLICATION

This application claims priority under 35 U.S.C. § 120 to PCT International Application Number PCT/EP2003/009286, filed on Aug. 21, 2003 and published in the English language, which claims priority under 35 U.S.C. § 119 to European Patent Application Number 02447158.3 filed on Aug. 21, 2002. The disclosures of the above-described filed applications are hereby incorporated by reference in their entirety.

### FIELD OF THE INVENTION

The invention relates to an object-oriented design method for the rapid development of production-grade embedded systems (hardware and software) based on a platform-independent system architecture of hardware and software objects, class model for hardware objects, software driver architecture, hardware framework architecture, prototyping apparatus therefor, and a configuration and integration GUI utility with associated software object class hierarchy for the abstraction of the hardware objects.

### BACKGROUND OF THE INVENTION

Currently, the design methodology observed for the hardware and software development of embedded systems offers little options for the reuse of development results obtained in previous projects. More often than not, the embedded system hardware design is custom for the project. Because the hardware design process is very time-consuming, the software development typically starts with a so-called processor reference platform which is acquired from a third party, often the processor vendor. This reference platform serves as development target for the application software of the embedded system until the hardware designed for the project becomes available. In many cases, the architecture of the reference platform only slightly resembles the architecture of the embedded system under development. This development flow has six important disadvantages:
1. Much work needs to be done to adapt the software developed with the reference platform as target to the embedded system hardware, increasing the development time, cost and risk.
2. The hardware design of the embedded system makes little or no use of hardware developed in previous projects. Essentially, the value of the engineering efforts invested in earlier projects is thus reduced to zero. At the same time, the hardware design of the embedded system is of little or no value for reuse, making them virtually worthless for future projects.
3. The hardware design process offers little flexibility for quick additions or changes. Once the hardware is developed, additions or changes require a new iteration in the hardware development process.
4. The system design is commonly based on proprietary hardware and software architectures, allowing little or no possibility to integrate hardware and software available from third parties in the embedded system under development.
5. The integration of hardware and software is mostly manual labor, and therefore extremely error-prone and time-consuming. Because this effort has to be done both for the reference platform and for the embedded system under development, the same effort is basically done twice. This again increases the development time, cost and risk.
6. The integration of hardware and software offers little or no option for automation with development tools.

All these items put a significant claim on the project schedule for the development of new embedded systems, along with the associated time, cost and risk to carry through the development of such systems. To avoid these difficulties in the prior art, it would be desirable to provide a system architecture and method which together enhance the development of embedded systems by:
1. Using the same architecture for the reference platform (hardware prototype) and hardware product,
2. Providing a reference platform which can be used to instantly create a hardware prototype,
3. Enabling a seamless transition from hardware prototype to hardware product,
4. Enabling complete reuse of development results from earlier projects,
5. Allowing the integration of hardware and software from third parties,
6. Automating the integration of hardware and software with development tools.

U.S. Pat. No. 5,870,588, Halambi et al. in “Automatic software toolkit generation embedded systems-on-chip”. ICVC '99. 6th International Conference on Seoul, South Korea, 26-27 Oct, 1999, and Sutarwala et al. in “Flexible modeling environment for embedded systems design” Hardware/software co-design, 1994, Proceedings of the third international workshop on Grenoble, France 22-24 September 1994, Los Alomos, Calif., USA, IEEE Comput. Soc. all relate to hard/software co-design methodologies for System-on Chip (ASIC). US 6 2002 147 B1 and EP 1 056 001 describe design techniques for the development of driver software.

### SUMMARY OF CERTAIN INVENTIVE EMBODIMENTS

The invention relates to an object-oriented design method for the development of production-grade embedded systems (hardware and software) based on a platform-independent standardized system architecture. In this system architecture, hardware objects and software objects implement the system functionality through standardized hardware and software interfaces. The hardware objects are integrated with a prototype hardware framework or a production hardware framework, both of which are functionally identical.

In a first aspect, the present invention relates to a system architecture for embedded systems based on hardware and software objects, in which the hardware objects are integrated with a hardware framework, and the software objects serve as driver interface with the embedded application software. The preferred embodiment of this aspect of the invention is referred to as bf3Board architecture.

In a second aspect, the present invention relates to an object-oriented design method for composing embedded systems from hardware objects with either a prototype hardware framework or production hardware framework. This enables the rapid development of new embedded systems. The preferred embodiment of this aspect of the invention is referred to as bf3DesignComposer method.

New is that the prototype hardware of the embedded system is immediately available for software development and that it is functionally identical to the production-grade counterpart, thus enabling a significant reduction of the hardware and software development time, cost, and risk. New is also that by employing the bf3DesignComposer design method, the development of new hardware objects which are compatible with the bf3Board architecture can take place asynchronously of the embedded system development.

A third aspect of the present invention relates to an apparatus which physically implements the prototype hardware framework. The preferred embodiment of this aspect of the present invention is referred to as bf3BaseBoard.

A fourth aspect of the present invention relates to a platform-independent architecture for driver software. The preferred embodiment of this aspect of the present invention is referred to as bf3Driver architecture.

A fifth aspect of the present invention relates to a Graphical User Interface (GUI) utility program which is used to configure the hardware objects through the software driver objects, and to integrate the software driver objects with the application software of the embedded system. A class hierarchy is used as abstraction of the hardware objects. The preferred embodiment of this aspect of the present invention is referred to as bf3BoardComposer software.

Regarding the third aspect of the invention, a physical implementation of the hardware framework is required to enable the rapid construction of hardware prototypes which are functionally identical to the embedded system under development.

Regarding the fourth aspect of the invention, a uniform architecture for driver software is required to enable the automated integration of drivers with the embedded system application software with development tools. The definition of such an architecture significantly simplifies the development of driver software, and the integration of such software with the application software of the embedded system.

Regarding the fifth aspect of the invention, currently, Graphical User Interface (GUI) utility programs for the configuration and integration of hardware objects are difficult to develop due to the lack of a uniform architecture for driver software. Making use of the driver architecture of the present invention, the process of integrating the hardware and software of the embedded system can be significantly shortened with the GUI utility program of the present invention.

The invention further relates to an apparatus which implements said prototyping hardware framework.

The invention further relates to a platform-independent architecture for driver software.

The invention further relates to a Graphical User Interface (GUI) utility which configures and integrates the hardware and software objects of said system architecture.

One embodiment of the invention is a platform-independent system architecture, an object-oriented design method, integration software and apparatus for the rapid development of production-grade embedded systems (hardware and software).

The system architecture of one embodiment of the present invention is based on the definition of hardware objects and a corresponding class model. These hardware objects, each represent a hardware function which is physically implemented with electronic circuitry.

The hardware objects implement a framework interface corresponding to the class model to which they belong. The following hardware object classes are defined in the present invention:
1. Processor Core Module hardware object class,
2. Processor Core Extension Module hardware object class,
3. Memory Bus Expansion Module hardware object class,
4. Serial Bus Expansion Module hardware object class,
5. Debug Interface Expansion Module hardware object class,
6. Power Distribution Module hardware object class.

The hardware objects are integrated to a hardware design by means of a hardware framework. The hardware frameworks do not provide any functionality, other than the integration of hardware objects itself. Because of this, the functional behavior of the embedded system hardware is not dependent of the selected framework.

Two classes of hardware frameworks are defined in the present invention:
1. A prototype hardware framework class,
2. A production hardware framework class.

A hardware framework provides interfaces with the hardware object classes it is able to integrate; these interfaces are compatible with the class model for hardware objects of the present invention.

Internally, a hardware framework according to one embodiment of the present invention consists mainly of a bus architecture which provides the interconnect structure between the hardware objects which together constitute the hardware design. This aspect is common to both hardware framework classes. In case of the prototype hardware framework, signal buffering and electromechanical interconnection is added. The preferred embodiment of the bus architecture of the present invention is referred to as bf3Bus.

In one embodiment of the invention, a hardware prototype of an embedded system can be created, which is functionally equivalent with the product-grade hardware. Also, because of the definition of the class model for hardware objects, two objects derived from the same class can be interchanged. For instance, a processor core object with a processor of type A can be exchanged for another processor core object with a processor of type B, without affecting the rest of the hardware design. Both features greatly facilitate the development of embedded systems.

A second aspect of the present invention is the object-oriented bf3DesignComposer design method for composing embedded systems (hardware and software) which enables the rapid development of new embedded systems by:
1. Selecting existing and defining new hardware objects which will together constitute the embedded system hardware,
2. Designing and developing said new hardware objects in accordance with the hardware object class definition.

3. Integrating the hardware objects with the prototyping hardware framework to build a hardware prototype,
4. Integrating the hardware objects with the production hardware framework to generate a production-grade hardware design,
5. Configuring and integrating the software objects associated with their respective hardware counterparts into the embedded application.

By following the bf3DesignComposer design methodology for the development of embedded system hardware, the reference platform of the prior art is replaced by a hardware prototype which is conceptually and functionally identical to the embedded system under development, thus avoiding the difficulties of the prior art. In addition, hardware objects can be developed asynchronously of the development of the embedded system, for instance by third parties from which they can be acquired. Furthermore, the bf3DesignComposer design methodology is beneficial for the reuse of hardware objects.

A third aspect of the present invention is an apparatus, referred to as bf3BaseBoard, which physically implements the prototype hardware framework class and the bf3Bus bus architecture. The bf3BaseBoard provides a limited number of electromechanical interfaces for each hardware object class. Thus, a hardware prototype of an embedded system can be built from existing hardware objects. New hardware objects can be added to the hardware prototype as they become available.

A fourth aspect of the present invention is the bf3Driver platform-independent software architecture for driver software objects which provide the interface between the hardware objects and the application software of the embedded system.

The bf3Driver architecture for driver software can be beneficial in certain embodiments as it enables formalizing the integration of the hardware and software of an embedded system. Without this formalization, automation of this integration process is sheer impossible.

A fifth aspect of the present invention is the bf3BoardComposer Graphical User Interface (GUI) utility program. Making use of the bf3Driver architecture of the present invention, it automates the process of integrating the hardware and software of the embedded system, thus avoiding the difficulties of the prior art. The bf3BoardComposer program is designed to operate under the Microsoft Windows family of operating systems.

Because the bf3BoardComposer Graphical User Interface (GUI) utility program does not interact directly with the hardware objects it configures, an abstraction model for the hardware objects is required. An object-oriented software class hierarchy serves this purpose. Technically, the software abstractions of the hardware objects are implemented as dynamic linked libraries (DLLs).

### BRIEF DESCRIPTION OF THE DRAWINGS

FIG. 1 is an overview of the bf3Board system architecture for embedded systems, according to the present invention, including a hardware framework [HwFw1] which integrates five (5) hardware objects [HwObj1:5]. The hardware objects are addressed by the application software of the embedded system through five (5) corresponding software objects [SwObj1:5].

FIG. 2 shows the class definition of a Processor Core Module hardware object [PcHwObj1], according to the class model for hardware objects of the present invention.

FIG. 3 shows the class definition of a Processor Core Extension Module hardware object [PcExHwObj1], according to the class model for hardware objects of the present invention.

FIG. 4 shows the class definition of a Memory Bus Expansion Module hardware object [MbeHwObj1], according to the class model for hardware objects of the present invention.

FIG. 5 shows the class definition of a Serial Bus Expansion Module hardware object [SbeHwObj1], according to the class model for hardware objects of the present invention.

FIG. 6 shows the class definition of a Debug Expansion Module hardware object [DbgHwObj1], according to the class model for hardware objects of the present invention.

FIG. 7 shows the class definition of a Power Distribution Module hardware object [PdHwObj1], according to the class model for hardware objects of the present invention.

FIG. 8 shows the structure of the bf3Bus bus architecture according to the present invention, for the interconnection of a Processor Core Module hardware object [PcHwObj2], a group of Memory Bus Expansion Module hardware objects [MbeHwObjGr1], a Debug Interface Expansion Module hardware object [DbgHwObj2], a group of Serial Bus Expansion Module hardware objects [SbeHwObjGr1], and a Power Distribution hardware object [PdHwObj2].

FIG. 9 shows the role of the Processor Core Extension Module hardware object within the context of the bf3Bus architecture, according to the present invention, for the interconnection of a Processor Core Module hardware object [PcHwObj3], a Memory Bus Expansion Module hardware object [MbeHwObj2], a Debug Interface Expansion Module hardware object [DbgHwObj3], a Serial Bus Expansion Module hardware object [SbeHwObj2], and a Power Distribution hardware object [PdHwObj3].

FIG. 10 shows an overview of the production hardware framework [HwFw2], according to the present invention, which is able to integrate:
1. one (1) hardware object of the Processor Core Module class [PcHwObj4]
2. one (1) hardware object of the Processor Core Extenstion Module class [PcExHwObj3]
3. five (5) hardware objects of the Memory Bus Expansion Module class [MbeHwObj3:7]
4. four (4) hardware objects of the Serial Bus Expansion Module class [SbeHwObj3:6]
5. one (1) hardware object of the Debug Interface Expansion Module class [DbgHwObj4]
6. one (1) hardware object of the Power Distribution Module class [PdHwObj4]
   by means of a bf3Bus interconnect structure [Bus1], according to the system architecture of the present invention.

FIG. 11 shows an overview of the prototype hardware framework [HwFw3], according to the present invention, which is able to integrate:
1. one (1) hardware object of the Processor Core Module class [PcHwObj5]
2. one (1) hardware object of the Processor Core Extenstion Module class [PcExHwObj4]
3. five (5) hardware objects of the Memory Bus Expansion Module class [MbeHwObj8:12]
4. four (4) hardware objects of the Serial Bus Expansion Module class [SbeHwObj7:10]
5. one (1) hardware object of the Debug Interface Expansion Module class [DbgHwObj5]
6. one (1) hardware object of the Power Distribution Module class [PdHwObj5]
   by means of a bf3Bus interconnect structure [Bus2], according to the system architecture of the present invention, in combination with a corresponding number of connector pairs and signal buffering entities.

FIG. 12 is a flow diagram describing the prior art design flow for the hardware and software development of embedded systems.

FIG. 13 is a flow diagram describing the bf3DesignComposer design method for the hardware and software development of embedded systems, according to the present invention.

FIG. 14 shows an embodiment of the bf3BaseBoard, according to the present invention. It provides:
1. one (1) slot to accommodate a hardware object of the Processor Core Module class [PcHwObj6]; and
2. five (5) slots to accommodate hardware objects of the Memory Bus Expansion Module class [MbeHwObj13:17]; and
3. four (4) slots to accommodate hardware objects of the Serial Bus Expansion Module class [SbeHwObj11:14]; and
4. one (1) slot to accommodate a hardware object of the Debug Interface Expansion Module class [DbgHwObj6].
   which are connected by means of a bf3Bus interconnect structure [Bus3], according to the system architecture of the present invention, in combination with a corresponding number of connector pairs and signal buffering entities.

The embodiment of the bf3BaseBoard as shown in FIG. 14 incorporates a hardware object of the Power Distribution Module class [PdHwObj6], and a hardware object of the Processor Core Extension Module class [PcExHwObj5].

FIG. 15 provides an abstraction model for the description of the bf3Driver architecture for driver software, according to the present invention, including a model for a Software Object [SwObj], a model for a Data Object [DataObj], a model for a Driver Table Entry Object [DrvObj], and a model for a Callback Function Object [CbObj].

FIG. 16 is a diagram of the bf3Driver architecture for driver software, according to the present invention, including three Hardware Objects [HwObj0:2], three associated Software Objects [SwObj0:2], three Data Objects [DataObj0:2], three Driver Table Entry Objects [DrvObj0:2], and three Callback Function Objects [Callback0:2];

FIG. 17 is the definition of the bf3Driver uniform driver interface in the C Programming Language, according to the present invention.

FIG. 18 shows an example of the bf3BoardComposer Graphical User Interface (GUI) utility program, according to the present invention.

FIG. 19 shows the class hierarchy for the abstraction of hardware objects by the bf3BoardComposer GUI utility program, according to the present invention.

### DETAILED DESCRIPTION CERTAIN INVENTIVE EMBODIMENTS

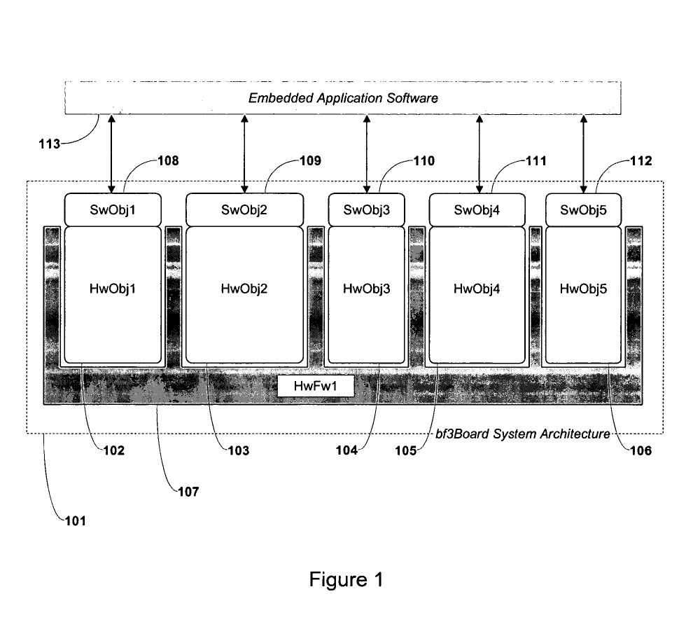

FIG. 1 shows the general concept of the object-oriented bf3Board system architecture 101 of the present invention, consisting of five hardware objects 102, 103, 104, 105, and 106 which are integrated to a hardware design with hardware framework 107. Five software objects 108, 109, 110, 111, and 112 perform the function of driver software and provide the programming interface for the embedded application software 113.

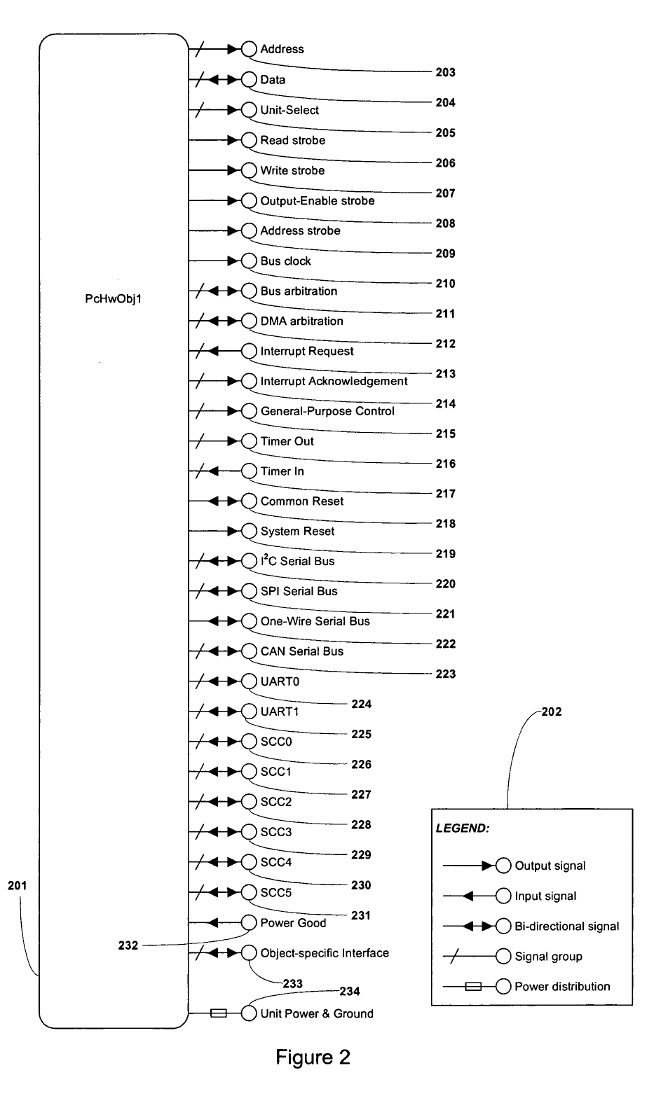

FIG. 2 provides the abstraction model 201 for hardware objects of the Processor Core Module class, according to the class model of the present invention. The interface of the Processor Core Module hardware object class is divided into signal groups which are each represented with a port symbol, as shown in legend 202.

As the name indicates, an object of the Processor Core Module hardware object class, performs the core processing function within the bf3Board system architecture of the present invention. This implies that in general terms, the functionality of a hardware object of the Processor Core Module hardware object class will be implemented by one or more embedded processors, with a memory configuration. All other functionality provided by the hardware design is implemented with objects of the other hardware object classes. The interface ports of the Processor Core Module hardware object class are mainly defined for interaction with objects of the other hardware object classes, according to the class model of the present invention.

The Processor Core Module hardware object class definition includes the following interface ports which together constitute a memory bus interface:
1. The address bus signal group 203
2. The data bus signal group 204
3. The Unit-Select signal group 205
4. The Read strobe signal 206
5. The Write strobe signal 207
6. The Output-Enable strobe signal 208
7. The Address strobe signal 209
8. The bus clock signal 210
9. The bus arbitration signal group 211
10. The Direct Memory Access (DMA) arbitration signal group 212

The signals of the Unit-Select signal group 205 each activate an individual hardware object within the hardware framework. The signals of the bus arbitration signal group 211 are used to grant access to the memory bus interface by one of the hardware objects within the hardware framework. The signals of the Direct Memory Access (DMA) arbitration signal group 212 are used allow a hardware object within the hardware framework to directly access memory within a hardware object of the Processor Core Module hardware object class.

An object of the Processor Core Module hardware object class provides the Interrupt Request signal group 213. The signals of this signal group can be used by other hardware objects within the hardware framework to raise an interrupt request. An object of the Processor Core Module hardware object class implements the Interrupt Acknowledgement signal group 214 to acknowledge the interrupt to the hardware object which raised it.

An object of the Processor Core Module hardware object class implements the General-Purpose Control signal group 215 to drive control inputs of other hardware objects within the hardware framework.

Timer signals can be accepted and/or provided by an object of the Processor Core Module hardware object class through the Timer In signal group 217 and Timer Out signal group 216, respectively.

Two types of reset signals exist within the bf3Board system architecture of the present invention: system reset and common reset. A system reset signal can only be generated by an object of the Processor Core Module hardware object class, for which it implements the System Reset interface port 219. The common reset can be generated by any hardware object within the hardware framework. An object of the Processor Core Module hardware object class implements the Common Reset interface port 218 for this purpose.

An object of the Processor Core Module hardware object class has interface ports for the following serial communications interfaces:
1. Inter-Integrated Circuit (I²C) serial bus 220
2. Serial Peripheral Interface (SPI) 221
3. One-wire serial bus 222
4. Controller Area Network (CAN) serial bus 223
5. Two Universal Asynchronous Receiver and Transmitter (UART) ports 224 and 225
6. Six Serial Communications Channels (SCC) 226, 227, 228, 229, 230, and 231

To monitor the integrity of the system power supply, an object of the Processor Core Module hardware object class, provides the Power Good input signal 232. The power supply itself is provided through the Power & Ground interface port 234.

An object of the Processor Core Module hardware object class may implement an object-specific interface 233 to provide a processor-specific interface with compatible hardware objects within the hardware framework.

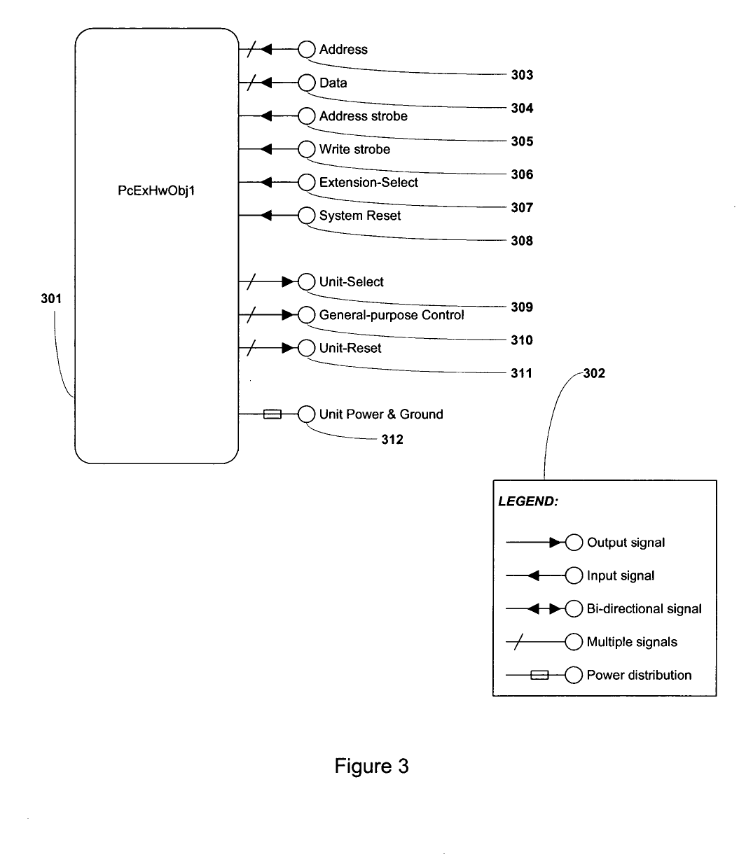

FIG. 3 provides the abstraction model 301 for hardware objects of the Processor Core Extension Module class, according to the class model of the present invention. The interface of the Processor Core Extension Module hardware object class is divided into signal groups which are each represented with a port symbol, as shown in legend 302.

An object of the Processor Core Extension Module hardware object class can be integrated into a hardware framework for either of the following purposes:
1. To increase the number of General-Purpose Control signals available to an object of the Processor Core Module hardware object class.
2. To increase the number of Unit-Select signals available to an object of the Processor Core Module hardware object class.
3. To create a reset signal distribution by which each hardware object in the hardware framework can receive an individual reset signal, rather than the global System Reset.

An object of the Processor Core Extension Module hardware object class is connected to the memory bus interface of an object of the object of the Processor Core Module class through the following interface ports:
1. The address bus signal group 303
2. The data bus signal group 304
3. The Address strobe signal 305
4. The Write strobe signal 306
5. The Extension-Select signal 307

The Extension-Select signal 307 is connected to a signal of the Unit Select signal group of an object of the Processor Core Module hardware object class.

An object of the Processor Core Extension Module hardware object class provides the following (output) signal groups to achieve the aforementioned functionality:
1. Unit-Select signal group 309
2. General-Purpose Control signal group 310
3. Unit-Reset signal group 311

The signals of the Unit-Reset signal group 311 are used to individually activate the Unit Reset input signals of the hardware objects within the hardware framework. When the System Reset signal 308 is activated by an object of the Processor Core Module hardware object class, all signals of the Unit Reset signal group 309 are also activated.

The power supply for an object of the Processor Core Extension Module hardware object class is provided through the Power & Ground interface port 312.

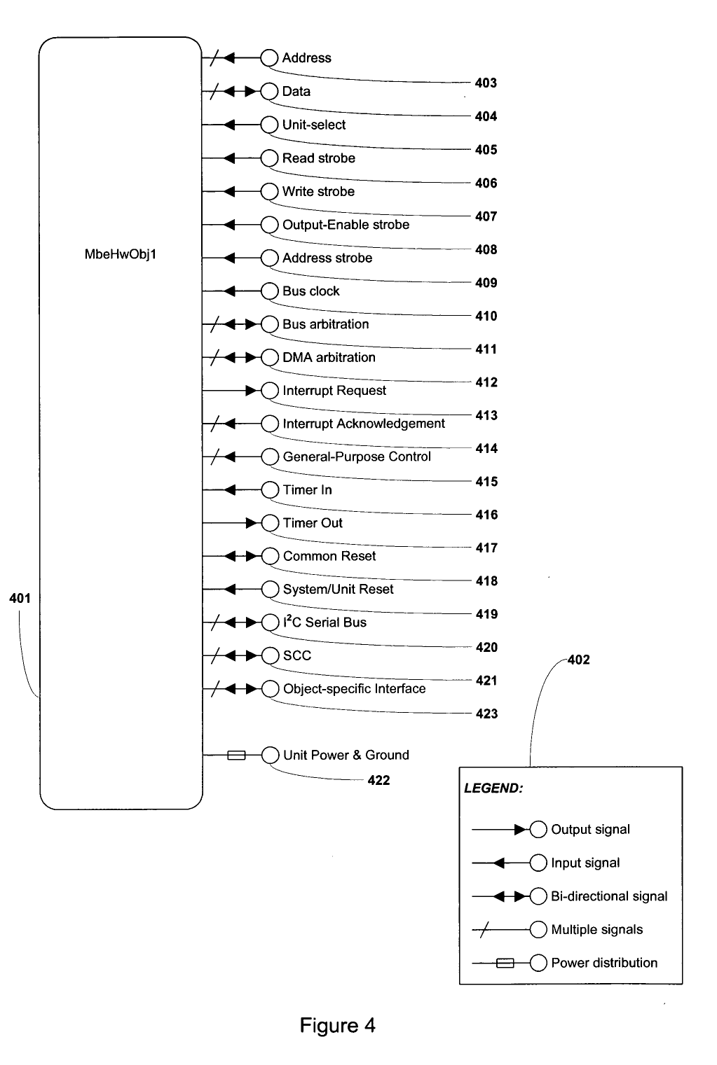

FIG. 4 provides the abstraction model 401 for hardware objects of the Memory Bus Expansion Module class, according to the class model of the present invention. The interface of the Memory Bus Expansion Module hardware object class is divided into signal groups which are each represented with a port symbol, as shown in legend 402.

An object of the Memory Bus Expansion Module hardware object class extends the functionality of an object of the Processor Core Module hardware object class, for which it provides a number of interface ports.

The Memory Bus Expansion Module hardware object class definition includes the following interface ports which together constitute the interface with the memory bus interface of an object of the Processor Core Module hardware object class:
1. The address bus signal group 403
2. The data bus signal group 404
3. The Unit-Select signal 405
4. The Read strobe signal 406
5. The Write strobe signal 407
6. The Output-Enable strobe signal 408
7. The Address strobe signal 409
8. The bus clock signal 410
9. The bus arbitration signal group 411
10. The Direct Memory Access (DMA) arbitration signal group 412

The Unit-Select signal 405 is connected to a signal of the Unit-Select signal group of an object of the Processor Core Module hardware object class or of an object of the Processor Core Extension Module hardware object class.

An object of the Memory Bus Expansion Module hardware object class can raise an interrupt request at an object of the Processor Core Module hardware object class through Interrupt Request signal 413. An object of the Memory Bus Expansion Module hardware object class can detect the acknowledgement of an interrupt request through the Interrupt Acknowledgement signal group 414.

An object of the Memory Bus Expansion Module hardware object class provides the General-Purpose Control input signal group 415 to provide direct access to ‘on/off’ functions within an object of the Memory Bus Expansion Module hardware object class. These functions are object-specific and must be published for each hardware object of the Memory Bus Expansion Module hardware object class which implements this interface port.

A timer signal can be accepted and/or provided by an object of the Memory Bus Expansion Module hardware object class through the Timer In signal 416 and Timer Out signal 417, respectively.

An object of the Memory Bus Expansion Module hardware object class can be reset in either of two ways: (1) the System/Unit Reset signal 419 is activated, or (2) the Common Reset signal 418 is activated. An object of the Memory Bus Expansion Module hardware object class can also drive the Common Reset signal 418 to reset all hardware objects within the hardware framework. The System/Unit Reset signal 419 is either driven by the System Reset signal of an object of the Processor Core Module hardware object class, or by a Unit Reset signal of an object of the Processor Core Extension Module hardware object class.

An object of the Memory Bus Expansion Module hardware object class provides two interface ports for the following serial communications interfaces:
1. Inter-Integrated Circuit (I²C) serial bus 420
2. Serial Communications Channel 421

The power supply for an object of the Memory Bus Expansion Module hardware object class is provided through the Power & Ground interface port 422.

An object of the Memory Bus Expansion Module hardware object class may implement an object-specific interface 423 to be compatible with hardware objects of the Processor Core Module hardware object class which implement an object-specific interface.

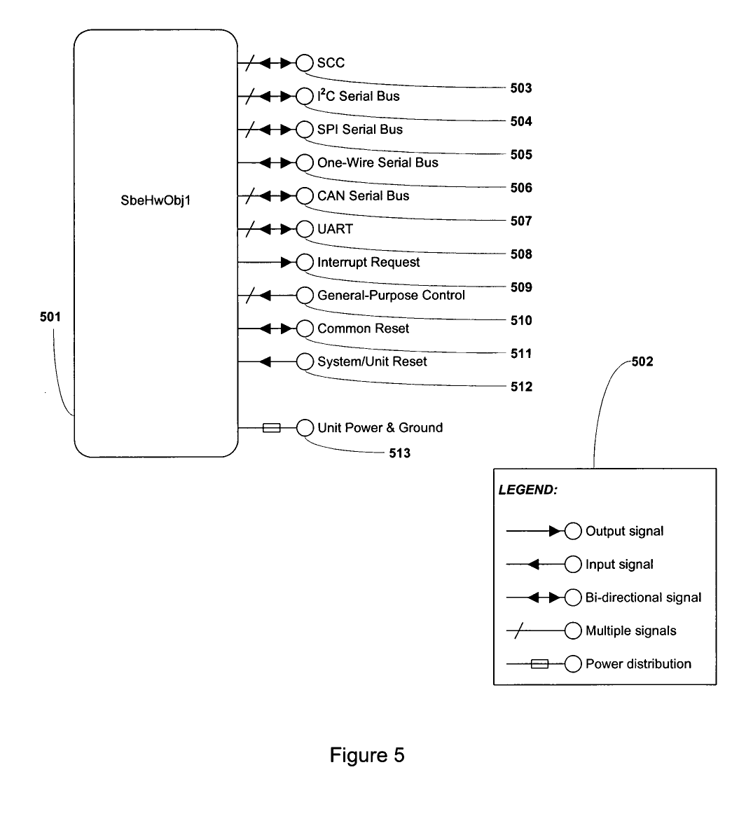

FIG. 5 provides the abstraction model 501 for hardware objects of the Serial Bus Expansion Module class, according to the class model of the present invention. The interface of the Serial Bus Expansion Module hardware object class is divided into signal groups which are each represented with a port symbol, as shown in legend 502.

An object of the Serial Bus Expansion Module hardware object class extends the functionality of an object of the Processor Core Module hardware object class, for which it provides a number of interface ports.

An object of the Serial Bus Expansion Module hardware object class has interface ports for the following serial communications interfaces:
1. Serial Communications Channel (SCC) 503
2. Inter-Integrated Circuit (I²C) serial bus 504
3. Serial Peripheral Interface (SPI) 505
4. One-wire serial bus 506
5. Controller Area Network (CAN) serial bus 507
6. Universal Asynchronous Receiver and Transmitter (UART) ports 508

An object of the Serial Bus Expansion Module hardware object class can raise an interrupt request at an object of the Processor Core Module hardware object class through Interrupt Request signal 509.

An object of the Serial Bus Expansion Module hardware object class provides the General-Purpose Control input signal group 510 to provide direct access to ‘on/off’ functions within an object of the Serial Bus Expansion Module hardware object class. These functions are object-specific and must be published for each hardware object of the Serial Bus Expansion Module hardware object class which implements this interface port.

An object of the Serial Bus Expansion Module hardware object class can be reset in either of two ways: (1) the System/Unit Reset signal 512 is activated, or (2) the Common Reset signal 511 is activated. An object of the Serial Bus Expansion Module hardware object class can also drive the Common Reset signal 511 to reset all hardware objects within the hardware framework. The System/Unit Reset signal 512 is either driven by the System Reset signal of an object of the Processor Core Module hardware object class, or by a Unit Reset signal of an object of the Processor Core Extension Module hardware object class.

The power supply for an object of the Serial Bus Expansion Module hardware object class is provided through the Power & Ground interface port 513.

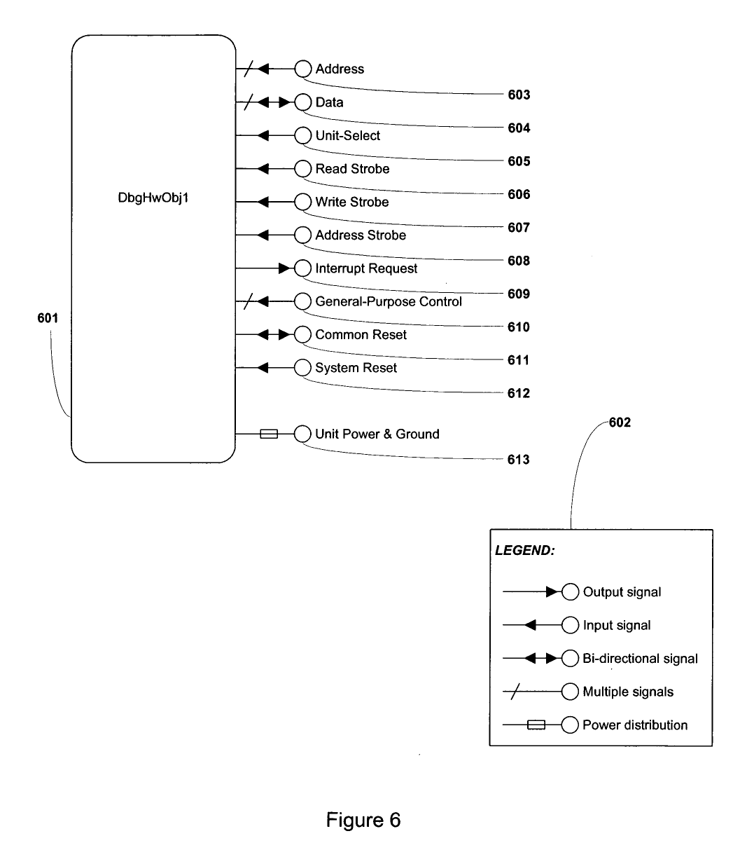

FIG. 6 provides the abstraction model 601 for hardware objects of the Debug Interface Expansion Module class, according to the class model of the present invention. The interface of the Debug Interface Expansion Module hardware object class is divided into signal groups which are each represented with a port symbol, as shown in legend 602.

An object of the Debug Interface Expansion Module hardware object class extends the functionality of an object of the Processor Core Module hardware object class by displaying status information and logging events, for which it provides a number of interface ports.

The Memory Bus Expansion Module hardware object class definition includes the following interface ports which together constitute the interface with the memory bus interface of an object of the Processor Core Module hardware object class:
1. The address bus signal group 603
2. The data bus signal group 604
3. The Unit-Select signal 605
4. The Read strobe signal 606
5. The Write strobe signal 607
6. The Address strobe signal 608
7. The bus clock signal 609

The Unit-Select signal 605 is connected to a signal of the Unit-Select signal group of an object of the Processor Core Module hardware object class or of an object of the Processor Core Extension Module hardware object class.

An object of the Debug Interface Expansion Module hardware object class provides the General-Purpose Control input signal group 610 to provide direct access to ‘on/off’ functions within an object of the Debug Interface Expansion Module hardware object class. These functions are object-specific and must be published for each hardware object of the Debug Interface Expansion Module hardware object class which implements this interface port.

An object of the Debug Interface Expansion Module hardware object class can be reset in either of two ways: (1) the System/Unit Reset signal 612 is activated, or (2) the Common Reset signal 611 is activated. An object of the Debug Interface Expansion Module hardware object class can also drive the Common Reset signal 611 to reset all hardware objects within the hardware framework. The System/Unit Reset signal 612 is either driven by the System Reset signal of an object of the Processor Core Module hardware object class, or by a Unit Reset signal of an object of the Processor Core Extension Module hardware object class.

The power supply for an object of the Debug Interface Expansion Module hardware object class is provided through the Power & Ground interface port 613.

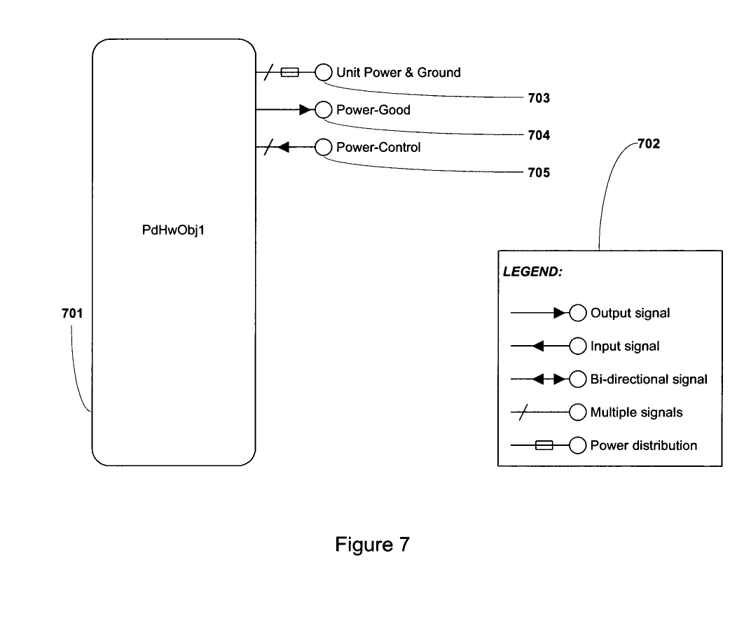

FIG. 7 provides the abstraction model 701 for hardware objects of the Power Distribution Module class, according to the class model of the present invention. The interface of the Power Distribution hardware object class is divided into signal groups which are each represented with a port symbol, as shown in legend 702.

The Unit Power & Ground interface port 703 provides the power supply for the hardware objects within the hardware framework, which physically distributes the power. The integrity of the power supply is indicated by the Power Good signal 704, which is monitored by an object of the Processor Core Module hardware object class. To control the operation of an object of the Power Distribution Module class, a Power Control interface port 705 is provided. The signals of the Power Control interface port 705 are driven with General-Purpose Control signals of an object of the Processor Core Module hardware object class, or of an object of the Processor Core Extension Module hardware object class.

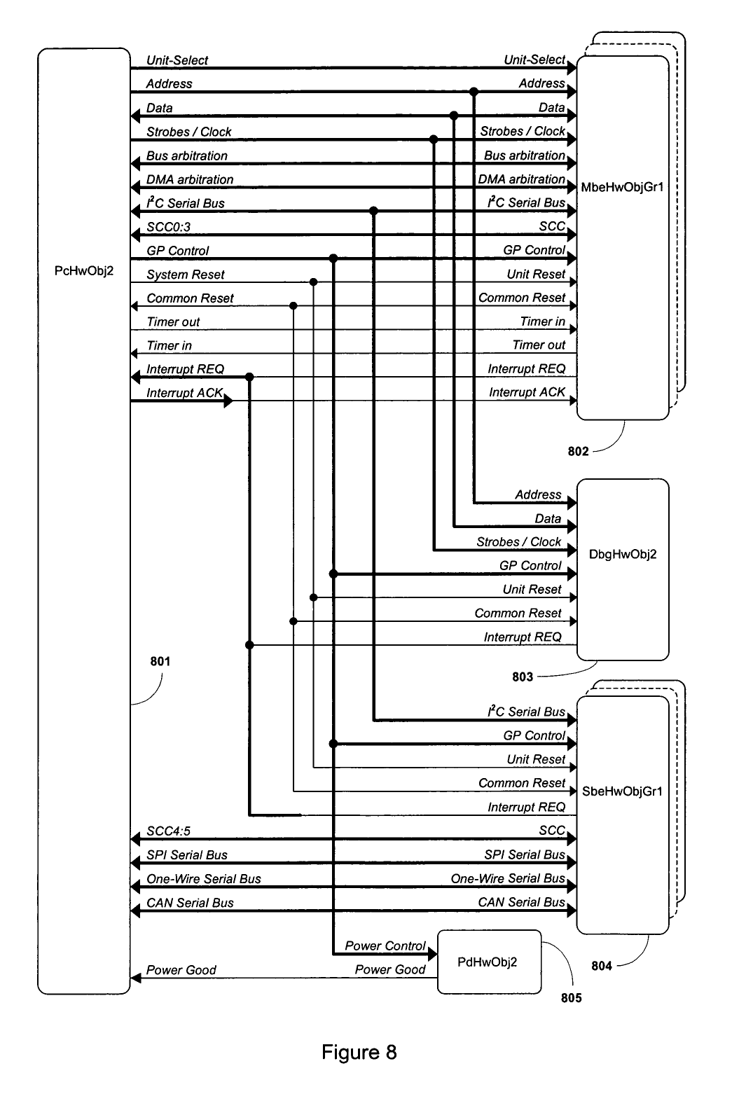

FIG. 8 provides an overview of the bf3Bus bus architecture, according to the present invention. The bf3Bus bus architecture serves as interconnect structure for a collection of hardware objects. In FIG. 8, the bf3Bus bus architecture connects a hardware object of the Processor Core Module class 801 with:
1. A group of hardware objects of the Memory Bus Expansion Module class 802; and
2. A hardware object of the Debug Interface Expansion Module class 803; and
3. A group of hardware objects of the Serial Bus Expansion Module class 804; and
4. A hardware object of the Power Distribution Module class 805.

The interconnect structure implemented by the bf3Bus architecture of the present invention connects the hardware objects of the class model for hardware objects of the present invention as described for FIGS. 2, 3, 4, 5, 6, and 7. Not shown in FIG. 8 are the Power & Ground interface ports of all hardware objects, nor the object-specific interface ports of the hardware objects of the Processor Core Module and Memory Bus Expansion Module classes.

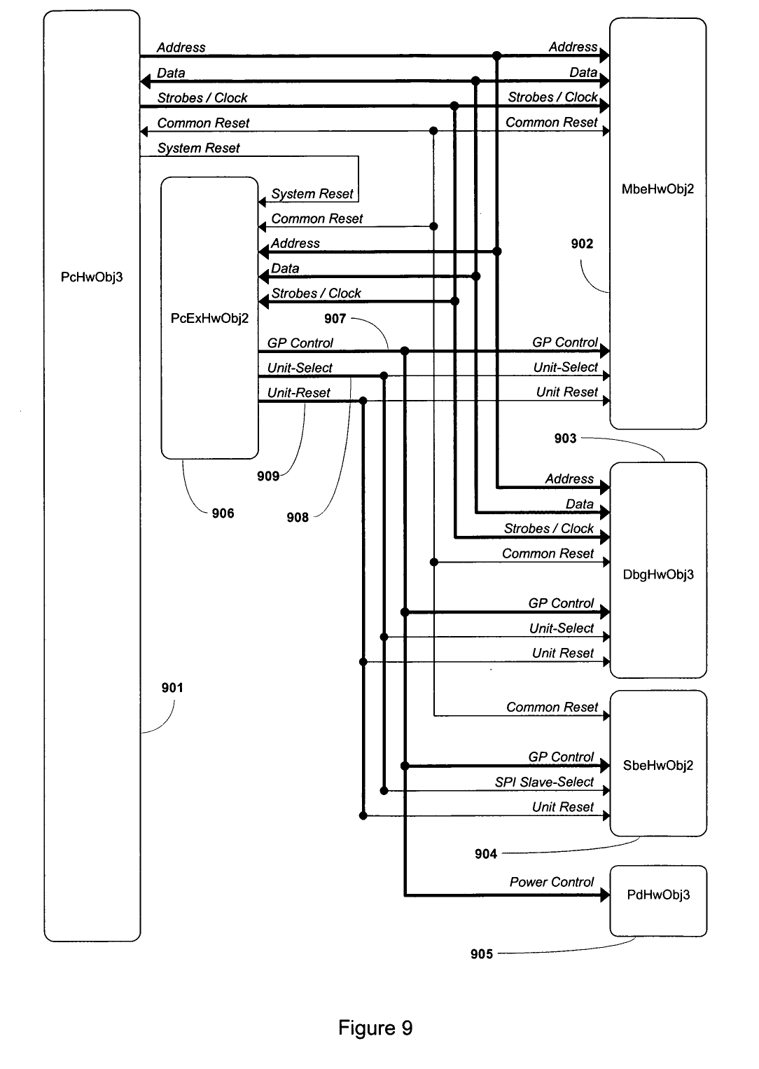

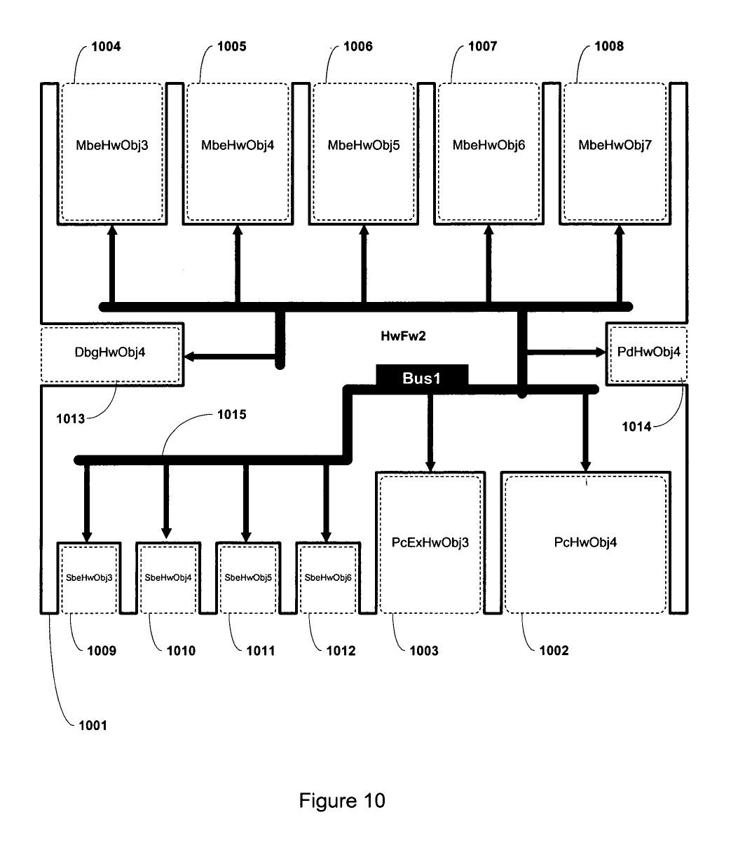

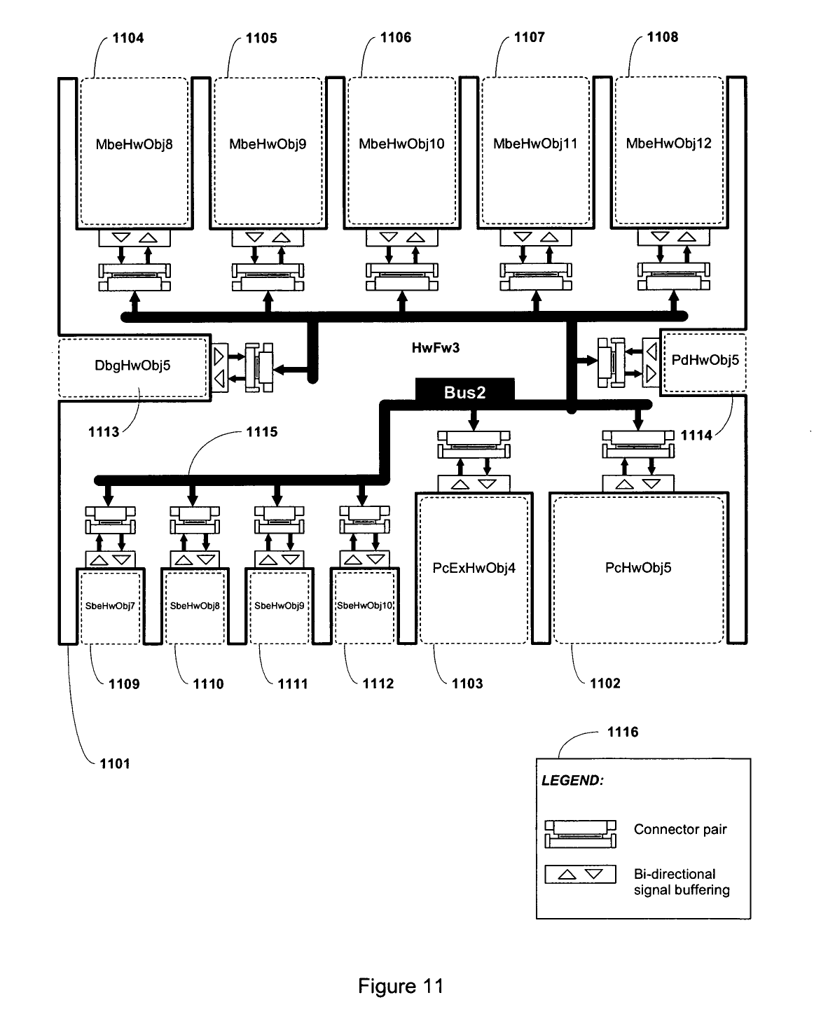

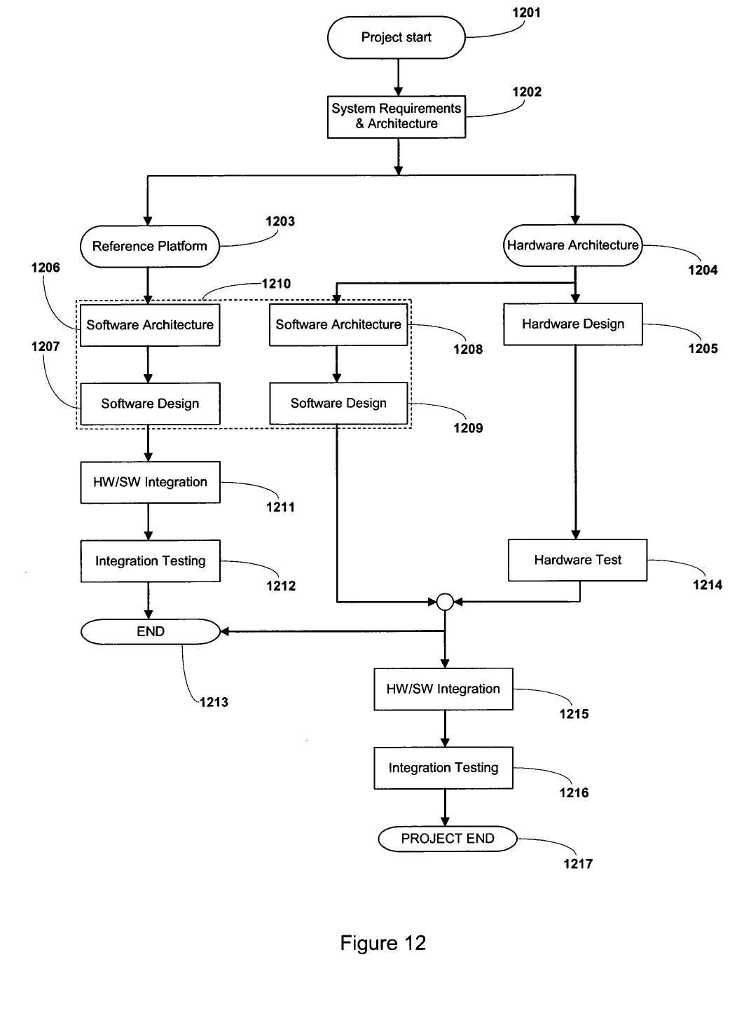

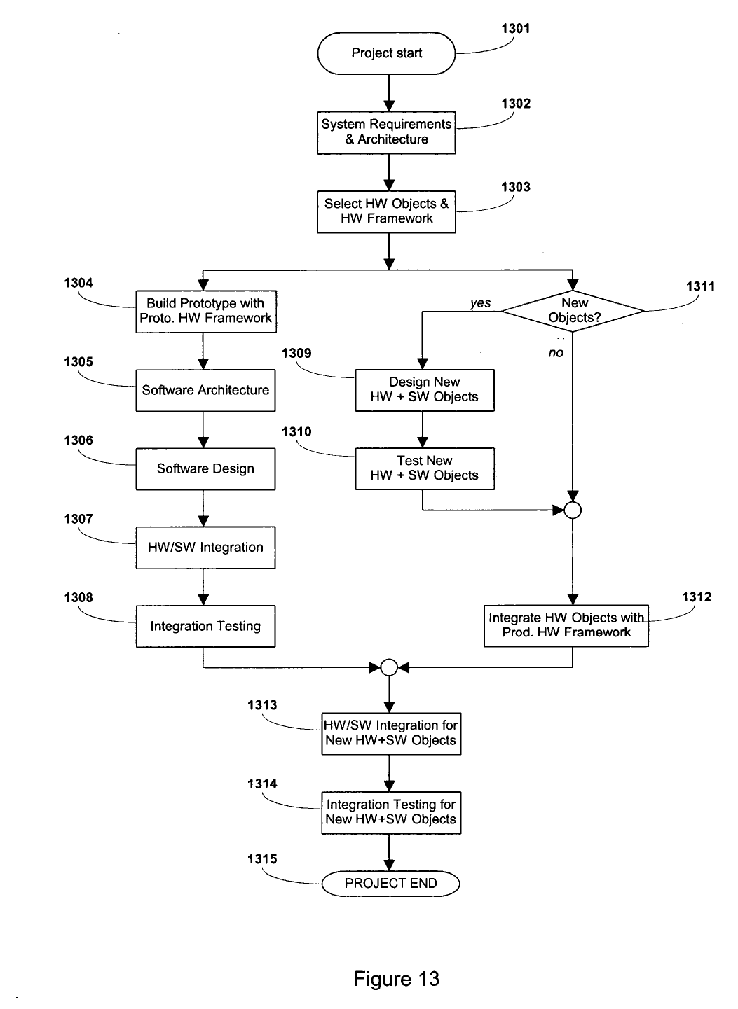

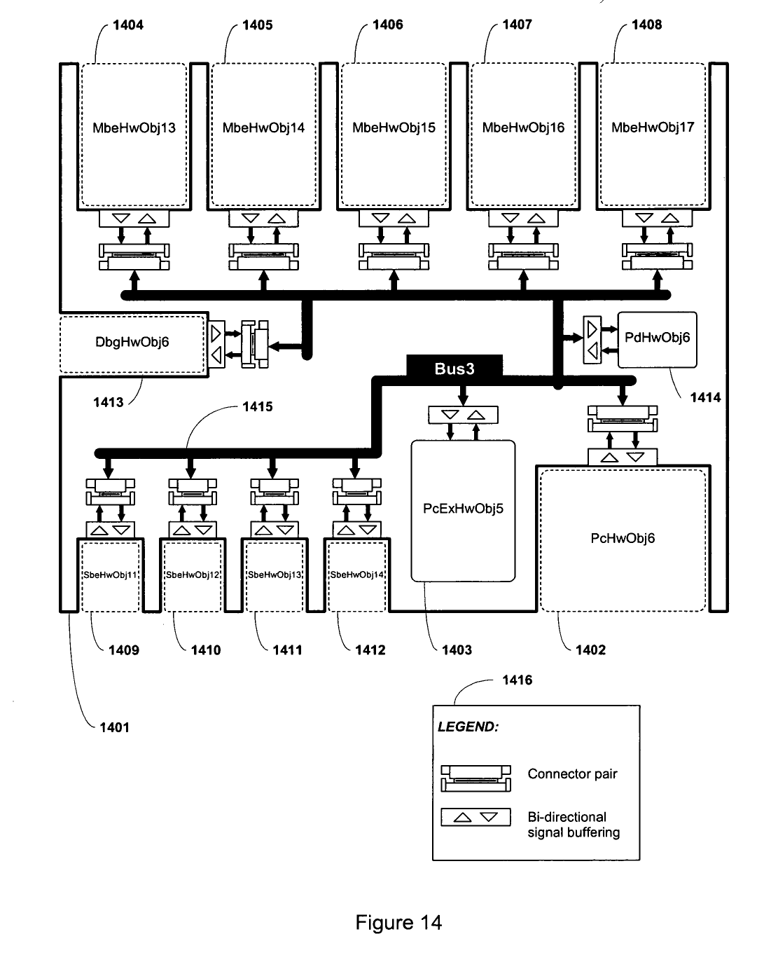

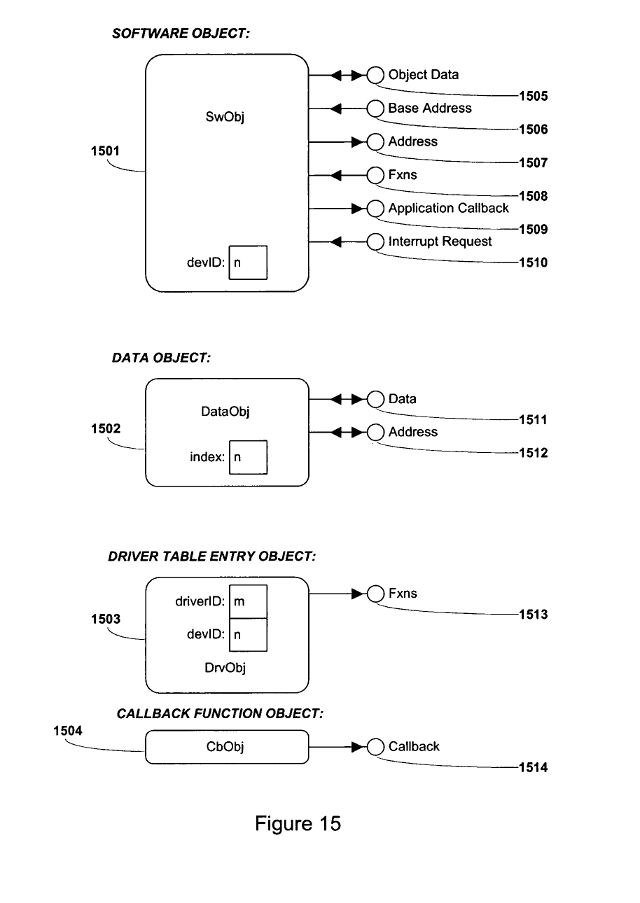

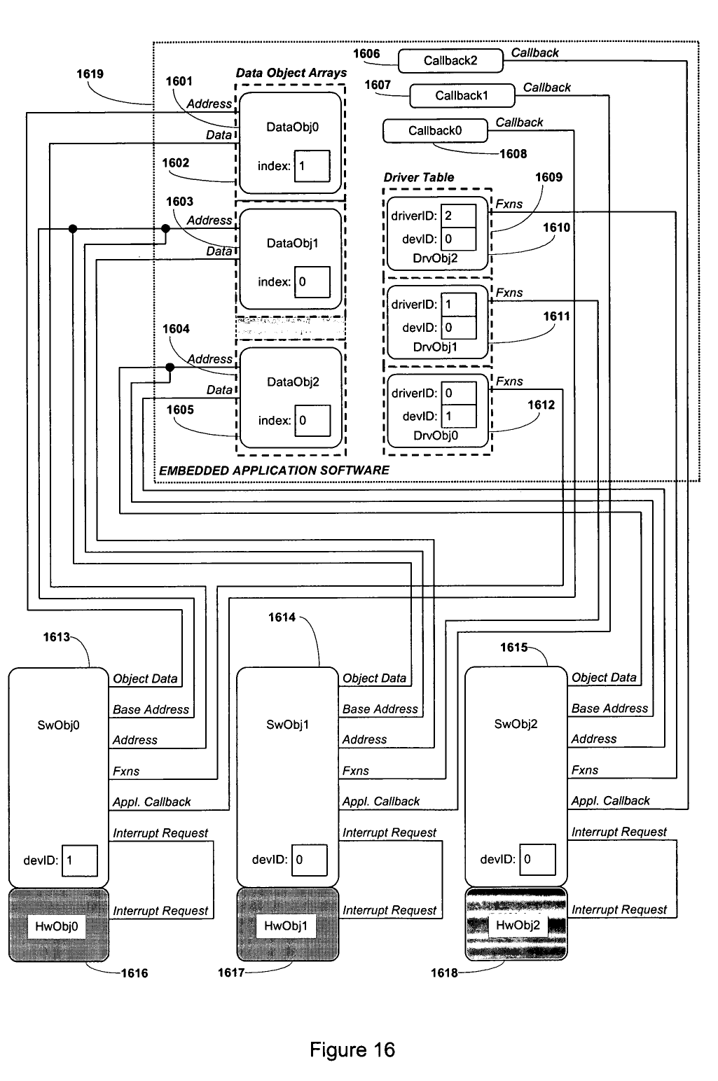

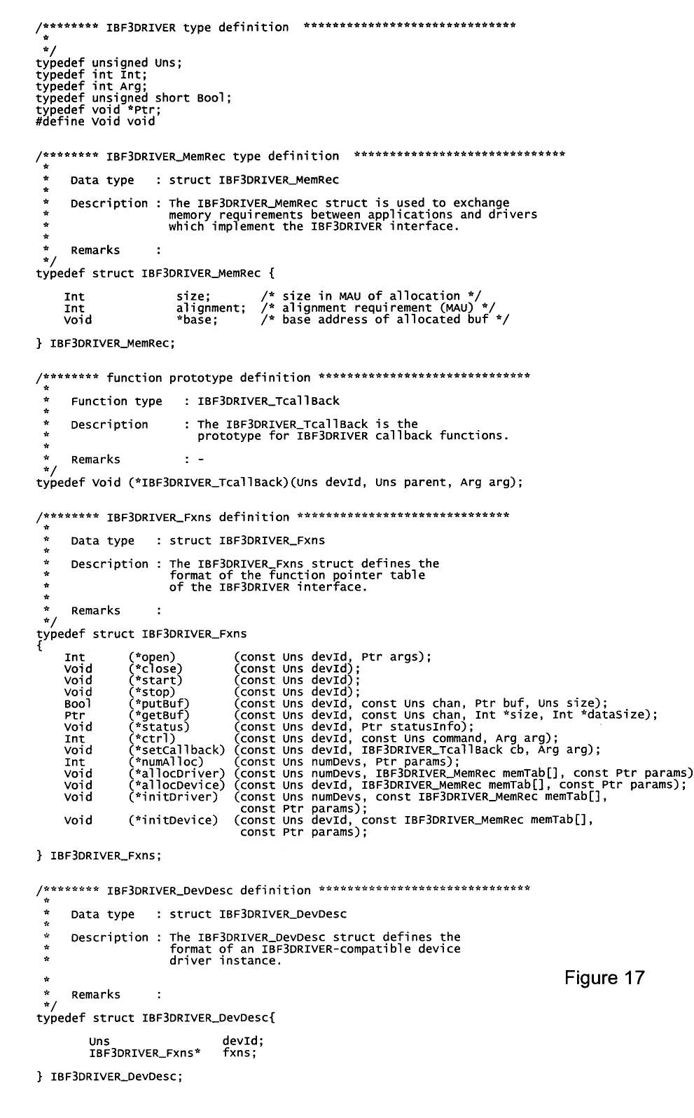

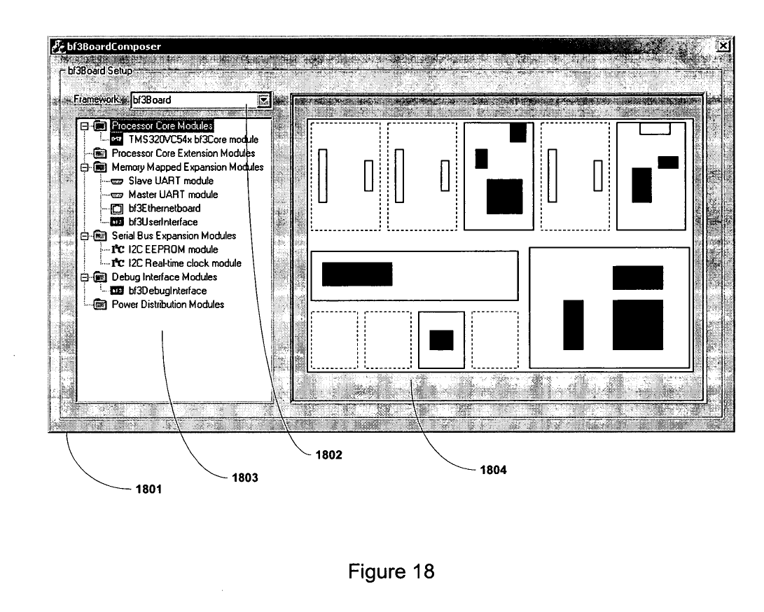

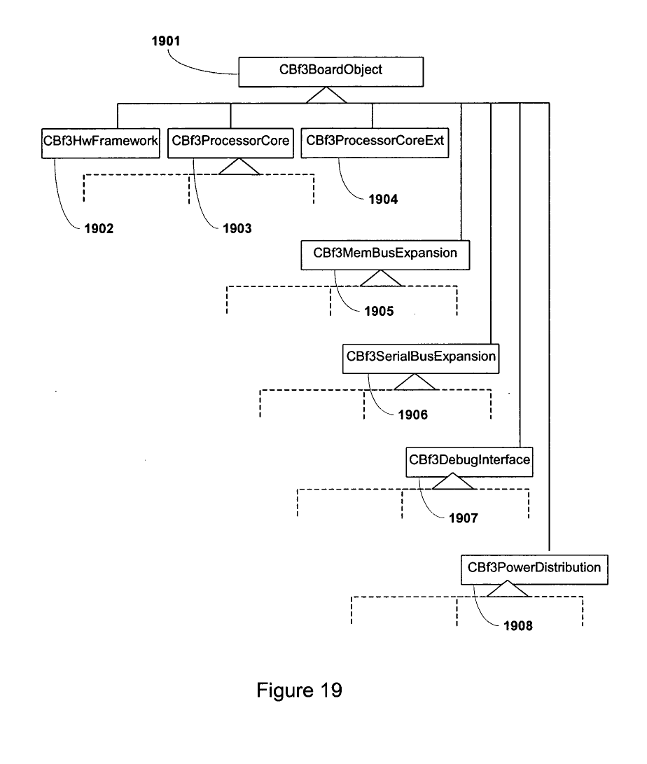

FIG. 9 shows the function of a hardware object of the Processor Core Extension Module class 906, according to the class model for hardware objects of the present invention, within the context of the bf3Bus bus architecture of the present invention.

The hardware object of the Processor Core Extension Module class 906 extends the functionality of a hardware object of the Processor Core Module class 901 by generating an additional:
1. General-Purpose Control output signal group 907
2. Unit-Select output signal group 908
3. Unit-Reset output signal group 909

The (output) signals of these signal groups are used to drive the corresponding inputs of a hardware object of the:
1. Memory Bus Expansion Module class 902
2. Debug Interface Expansion Module class 903
3. Serial Bus Bus Expansion Module class 904
4. Power Distribution Module class 905

In case of the hardware object of the Serial Bus Expansion Module class 904, the Unit-Select signal is used to drive the Slave-Select signal of the Serial Peripheral Interface (SPI) interface port.

The signals of the Unit-Reset signal group 909 are used to individually reset the hardware objects which are interconnected by the bf3Bus bus architecture of the present invention.

FIG. 10 provides an overview of a production hardware framework 1001, according to the bf3Board system architecture of the present invention. This production hardware framework 1001 provides a number of so-called hardware object slots, which can accommodate a corresponding number of compatible hardware objects, according to the class model for hardware objects of the present invention.

The production hardware framework 1001 shown in FIG. 10 can accommodate:
1. One (1) hardware object of the Processor Core Module class 1002; and
2. One (1) hardware object of the Processor Core Extension Module class 1003; and
3. Five (5) hardware objects of the Memory Bus Expansion Module class 1004,1005,1006, 1007, and 1008; and
4. Four (4) hardware objects of the Serial Bus Expansion Module class 1009, 1010, 1011, and 1012; and
5. One (1) hardware object of the Debug Interface Expansion Module class 1013; and
6. One (1) hardware object of the Power Distribution Module class 1014.

The production hardware framework 1001 connects these hardware objects by means of an instance of the bf3Bus architecture 1015 of the present invention. Thus, the production hardware framework 1001 integrates the hardware objects to a production-grade hardware design for an embedded system, according to the bf3Board system architecture of the present invention.

FIG. 11 provides an overview of a prototype hardware framework 1101, according to the bf3Board system architecture of the present invention. This prototype hardware framework 1101 provides a number of so-called hardware object slots, which can accommodate a corresponding number of compatible hardware objects, according to the class model for hardware objects of the present invention.

The prototype hardware framework 1101 shown in FIG. 11 can accommodate:
1. One (1) hardware object of the Processor Core Module class 1102; and
2. One (1) hardware object of the Processor Core Extension Module class 1103; and
3. Five (5) hardware objects of the Memory Bus Expansion Module class 1104, 1105, 1106, 1107, and 1108; and
4. Four (4) hardware objects of the Serial Bus Expansion Module class 1109, 1110,1111, and 1112; and
5. One (1) hardware object of the Debug Interface Expansion Module class 1113; and
6. One (1) hardware object of the Power Distribution Module class 1114.

The prototype hardware framework 1101 connects these hardware objects by means of an instance of the bf3Bus architecture 1115 of the present invention.

The main purpose of the prototype hardware framework 1101 of the present invention, is to enable the construction of a prototype of the embedded system hardware at the beginning of the system development, which is functionally identical with an embedded system in which the hardware objects are integrated with a production hardware framework as described for FIG. 10.

In practice, the hardware objects and the prototype hardware framework will be implemented as a set of Printed Circuit Boards (PCBs) with electronic circuitry, which implements the functionality of the hardware object or the prototype hardware framework.

The hardware objects of each class, according to the class model for hardware objects of the present invention, and the prototype hardware framework will have standard mechanical dimensions. To integrate the hardware object PCBs and the prototype hardware framework PCB, both must provide a part of a mating connector pair, with a standardized signal-to-pin assignment, and mechanical connector locations. For this reason, in the prototype hardware framework, a connector pair is added to each interface between a hardware object and the bf3Bus interconnect structure. The symbol used to depict a connector pair is contained in the symbol legend 1116.

In case the standardized mechanical dimensions imply that the signal traces which physically implement the bf3Bus interconnect, are too long to maintain the electrical integrity of the signals carried by the bf3Bus interconnect structure, additional signal buffering will be required. For this reason, in the prototype hardware framework, a bidirectional signal buffer (transceiver) is added to each interface between a hardware object and the bf3Bus interconnect structure. The symbol used to depict a bidirectional signal buffer is contained in the symbol legend 1116.

It is important to point out that, although the signal buffering entity and one part of the connector pair will be implemented on the PCB carrying the electronic circuitry which implements the functionality of a hardware object, these two elements are still considered to be part of the prototype hardware framework 1101, according to the bf3Board architecture for embedded systems of the present invention.

Thus, the prototype hardware framework 1101 integrates the hardware objects to a hardware prototype of an embedded system which will be functionally identical with the production version of the same embedded system, which is acquired by integrating the hardware objects with the production framework, according to the bf3Board system architecture of the present invention.

FIG. 12 provides a flow diagram of the development of a new embedded system, as it is currently common practice (prior art), consisting of a number of discrete development steps.

After the Project Start 1201, the Product Requirements and System Architecture are determined in step 1202. After the Requirements and Architecture phase 1202, the product development flow of the embedded system is divided into two mainly independent paths:
1. One path starting with the definition 1204 of the Hardware Architecture of the embedded system under development; and
2. Another path starting with the selection 1203 of a suitable Reference Platform.

The reason for this approach is the lead time which is inherently associated with the development of the embedded system hardware. Because of the nature of embedded systems, where the embedded system is designed to perform a project-specific set of functions, most projects require a unique hardware and software architecture.

To partially overcome this deficiency, in the prior art, commercially available hardware or the hardware of a previously developed embedded system is initially used for the development of the embedded software, until the Hardware Design phase 1205 and Hardware Test phase 1214 have been completed.

In many cases, the reference platform and embedded system under development will have disimilar hardware architectures. Because a software architecture is strongly dependent of the architecture of the underlying embedded system hardware, this implies that two distinct software architecture definition steps are required:
1. A Software Architecture definition 1206, based on the hardware architecture of the selected reference platform; and
2. A Software Architecture definition 1208, based on the hardware architecture of the embedded system under development.

As a result, two distinct Software Design steps 1207 and 1209 are also required. Within the area marked by the dashed line 1210, the design engineers involved in the development of the embedded system will be forced to develop software which is only suitable for either of both target platforms. This creates additional overhead in the development schedule.

When the Software Design phase 1207 for the reference platform has been completed, the developed software will be integrated with reference platform hardware in step 1211. Upon completion of this phase, the Integration Testing phase 1212 commences. This phase will be terminated (step 1213) when the Hardware Test phase 1214 is completed, and the hardware for the embedded system under development becomes available.

Now, a new integration phase (step 1215) is started, in which the software developed specifically for the embedded system under development will be integrated with the hardware which has recently become available. In essence, the work done in step 1211 for the reference platform is repeated for the embedded system hardware in step 1215. The same applies for the Integration Testing phase 1216, which repeats the work of phase 1212. The Project End 1217 is reached, when the Integration Testing phase 1216 is completed.

FIG. 13 shows the development flow of the bf3DesignComposer method, according to the present invention.

As can be concluded from the description of the development flow shown in FIG. 12, the prior art process for the development of new embedded systems has the following deficiencies:
1. The hardware of the new embedded system is specifically developed to perform the required functions; it makes little use of previous development result, and at the same time offers little value for reuse.
2. The software development process is complex; it requires that the same work is done twice.

The bf3DesignComposer method, based on the bf3Board system architecture, according to the present invention, to a large extent enables the elimination of these deficiencies.

In the bf3DesignComposer design method of the present invention, after the Project Start 1301 and the System Requirements and Architecture phase 1302, the hardware architecture of the embedded system, is based on the bf3Board system architecture of the present invention. In phase 1303, the hardware objects and the hardware framework which together constitute the hardware of the embedded system are selected.

The bf3DesignComposer design method of the present invention enables the effective reuse hardware objects developed in previous projects. Alternatively, hardware objects which are commercially acquired from third parties, can be integrated into the hardware design. Depending on the result of the decision 1311 if new hardware and corresponding software objects are required for the embedded system under development, the new hardware and software objects are developed and tested in phases 1309 and 1310, respectively. When all hardware objects required for the embedded system are available, they can be integrated with the production hardware framework (phase 1312). Thus, the hardware development process is reduced to the development of genuinely new functionality.

Meanwhile, the software development starts by building a prototype of the embedded system by integrating existing and commercially acquired hardware objects with a prototype hardware framework (phase 1304), as described for FIG. 11.

Since the hardware architectures of both the prototype embedded system and its production version are identical in the bf3DesignComposer design method of the present invention, only software which is actually required for the product needs to be developed.

Thus, the software development process can be simplified to a single flow consisting of:
1. Definition of a Software Architecture 1305
2. Software Design phase 1306
3. Hardware/Software Integration phase 1307
4. Integration Testing phase 1308

The bf3DesignComposer design method reduces the software development process to the development of functionality which is actually required for the production embedded system.

Once the production version of the embedded system becomes available with the completion of Hardware Integration phase 1312, the new hardware and software objects which were developed are integrated with the software in step 1313, after which Integration Testng 1314 for these new hardware and software objects takes place. When the Integration Testing phase 1314 has been completed, the Project End is 1315 is reached.

FIG. 14 shows an embodiment 1401 of the bf3BaseBoard, according to the present invention. The bf3BaseBoard physically implements the prototype hardware framework of the present invention, as described for FIG. 11. As such, it provides slots to accommodate:
1. One (1) hardware object of the Processor Core Module class 1402; and
2. Five (5) hardware objects of the Memory Bus Expansion Module class 1404, 1405, 1406, 1407, and 1408; and
3. Four (4) hardware objects of the Serial Bus Expansion Module class 1409, 1410, 1411, and 1412; and
4. One (1) hardware object of the Debug Interface Expansion Module class 1413.

In addition, the embodiment of the bf3BaseBoard as shown in FIG. 14 incorporates a hardware object of the Power Distribution Module class 1414, and a hardware object of the Processor Core Extension Module class 1403.

The bf3BaseBoard physically consists of a printed circuit board (PCB) which carries the electronic circuitry which implements the functionality of the bf3Bus interconnect structure 1415, the hardware object of the Power Distribution Module class 1414, and the hardware object of the Processor Core Extension Module class 1403.

The bf3BaseBoard implement a connector sockets for each implementation of a hardware object. The mechanical location of the connectors on the bf3BaseBoard PCB is defined for each hardware object class, according to the class model for hardware objects of the present invention. The pin assignment of the connector configuration for each slot is also defined.

Hardware objects which the bf3BaseBoard is able to integrate must implement a matching connector configuration, as well as bidirectional signal buffering, to account for the length of the signal traces of the bf3Bus interconnect structure 1415 on the bf3BaseBoard PCB.

For reasons of brevity, the bidirectional signal buffering and both parts of the connector pairs have been depicted in the bf3BaseBoard diagram of FIG. 14. The symbols used to depict a bidirectional signal buffer and a connector pair is contained in the symbol legend 1416.

The bf3BaseBoard enables the immediate creation of embedded system prototypes with hardware objects which have been developed to be compatible with the mechanical and electrical properties of the bf3BaseBoard.

FIG. 15 provides an abstraction model for the description of the bf3Driver architecture for driver software, according to the present invention. The following object are defined as part of the bf3Driver architecture of the present invention:
1. Software Object 1501
2. Data Object 1502
3. Driver Table Entry Object 1503
4. Callback Function Object 1504

Not shown in FIG. 14 is a model of the hardware object, according to the bf3Board System Architecture of the present invention; abstraction models for such hardware objects were shown in FIGS. 2, 3, 4, 5, 6, and 7.

The Software Object 1501 of the bf3Board System Architecture of the present invention provides a number of interface for the integration of the other objects of the bf3Driver architecture of the present invention. The Object Data interface 1505 is used to access Data Objects 1502 in the memory of the embedded system. The Base Address interface 1506 is used by the application software of the embedded to convey the base address of an array of Data Objects 1502 in the memory of the embedded system to a Software Object 1501. The Address interface 1507 is used by a Software Object 1507 to access a Data Object 1502 in the memory of the embedded system. The Fxns interface 1508 is used by the application software of the embedded application to access the internal function table of the Software Object 1501. The format of said function table will described with FIG. 17. The Application Callback interface 1509 is used by a Software Object 1501 to notify the application software of the embedded system of events which require the attention of said application software through a Callback Function Object 1504. The Interrupt Request interface 1510 is used by a hardware object of the bf3Board System Architecture of the present invention to raise an interrupt at the Software Object 1501. In practice, an interrupt request raised by a hardware object of the present invention will cause an Interrupt Service Routine (ISR) of the Software Object 1501 to be invoked by the processor of the embedded system. This procedure is well-known to a professional skilled in the art.

The Data Object 1502 provides a Data interface 1511, and an Address interface 1512. Both interfaces are used by a Software Object 1501 to access data stored by the Data Object 1502.

The Driver Table Entry Object 1503 links the application software of the embedded system to an instance of a Software Object 1501. It provides a single interface: the Fxns interface 1513 is used by the application software which addresses the Driver Table Entry Object 1503 to gain access to the internal function table of the Software Object 1501.

The Callback Function Object 1504, which is implemented by the application software of the embedded system, is accessed by a Software Object 1501 to notify said application software of an event which requires the attention of said application software. It provides the Callback interface 114 as entry point for the Software Object 1501.

FIG. 16 is a diagram of the bf3Driver architecture for driver software, according to the present invention.

FIG. 16 shows three hardware objects 1616, 1617, and 1618, together with three associated software objects 1613, 1614, and 1615, respectively, according to the bf3Board System Architecture of the present invention. In FIG. 16, hardware objects 1616 and 1617 are identical (indicated by the same fill pattern), 1618 implements functionality which differs from hardware objects 1617 and 1618.

Each software object is identified by a Device Identifier. Software objects are grouped by the functionality of their corresponding hardware objects. Each software object in such a group is assigned a Device Identfier which is unique within a group of software objects. In case of software objects 1614 and 1613, the Device Identifiers are set to ‘0’ and ‘1’, respectively. Within a group, the assignment of Device Identifiers must start at ‘0’. This rule also applies for groups of software objects which contain only a single software object.

The software objects 1613, 1614, and 1615 shown in FIG. 16 each have a data object associated with them (1601, 1603, and 1605, respectively). The data objects corresponding with a group of software objects are organized as an object array in the memory of the embedded system. The Device Identifiers of the software objects in a group of software objects serve as index of a data object in an array of said data objects. In figure data object array 1602 contains data objects 1601 and 1603, which are associated with software objects 1613 and 1614, respectively. Data object array 1604 contains a single data object 1605, associated with software object 1615.

A driver table entry object acts as entry point to a software object for the application software 1619 of the embedded system. Therefore, for each software object in the embedded system a driver table entry object must exist. The driver table entry objects are organized as an array to create a driver table 1609 in the memory of the embedded system. The entries 1610, 1611, and 1612 of the driver table 1609 provide access to software objects 1613,1614, and 1615, respectively. The index of a driver table entry object in the driver table 1609 can be seen as a unique Driver Identifier of a software object within the embedded system. The value of this Driver Identifier is set for software object 1613, 1614, and 1615 is set to ‘0’, ‘1’, and ‘2’, respectively.

Three callback function objects 1608, 1607, and 1606 enable the software objects 1613, 1614 and 1615, respectively to notify the application software of the embedded system 1619 of relevant events related to the operation of their corresponding hardware objects.

FIG. 17 is the definition of the bf3Driver uniform driver interface in the C Programming Language, according to the present invention, along with the required type definitions. The format of the IBF3DRIVER_Fxns function table is immediately understood by a professional skilled in the art.

FIG. 18 shows an example of the bf3BoardComposer Graphical User Interface (GUI) utility program 1801, according to the present invention. The bf3BoardComposer user interface 1801 contains a menu 1802 for the selection of the framework which is used to integrate the hardware objects, according to the bf3Board System Architecture of the present invention. The available hardware objects are listed in tree view 1803, grouped by their hardware object class, according to the class model for hardware objects of the present invention.

The user interface 1801 also contains a section 1804 in which the hardware objects can be assigned to a slot within the hardware framework selected by menu 1802.

FIG. 19 shows the class hierarchy for the abstraction of hardware objects by the bf3BoardComposer GUI utility program, according to the present invention.

All objects within the class hierarchy for the abstraction of hardware objects of the present invention are derived from the CBf3BoardObject root class 1901. For each hardware object class of the class model for hardware objects of the present invention, a subclass is derived from the CBf3BoardObject root class 1901:
1. The CBf3HwFramework class 1902 represents an implementation of a hardware framework, according to the bf3Board System Architecture of the present invention.
2. The CBf3Processor Core class 1903 serves as base class for hardware objects of the Processor Core Module hardware object class, according to the class model for hardware objects of the present invention.
3. The CBf3Processor CoreExt class 1904 serves as base class for hardware objects of the Processor Core Extension Module hardware object class, according to the class model for hardware objects of the present invention.
4. The CBf3MemBusExpansion class 1905 serves as base class for hardware objects of the memory Bus Expansion Module hardware object class, according to the class model for hardware objects of the present invention.
5. The CBf3SerialBusExpansion class 1906 serves as base class for hardware objects of the Memory Bus Expansion Module hardware object class, according to the class model for hardware objects of the present invention.
6. The CBf3DebugInterface class 1907 serves as base class for hardware objects of the Debug Interface Expansion Module hardware object class, according to the class model for hardware objects of the present invention.
7. The CBf3PowerDistribution class 1908 serves as base class for hardware objects of the Power Distribution Module hardware object class, according to the class model for hardware objects of the present invention.

For each hardware object which is developed, a new class must be derived from the corresponding base class within the class hierarchy for the abstraction of hardware objects, according to the present invention.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

1. A system architecture for embedded systems based on hardware and software objects, wherein the hardware objects are integrated with a hardware framework, and the software objects are configured as a software driver interface with embedded application software for the hardware objects.

2. The system architecture of claim 1, comprising a class model for hardware objects, wherein the class model categorizes hardware objects by their functional behavior and defines their system interface by one of the following classes:
a. processor core module hardware object class;
b. processor core extension module hardware object class;
c. memory bus expansion module hardware class;
d. serial bus expansion module hardware object class;
e. debug interface expansion module hardware object class; and
f. power and reset distribution module hardware object class.

3. The system architecture of claim 2, further comprising a bus architecture configured as an interconnect structure for the hardware objects derived from the class model.

4. The system architecture of claim 1, comprising a class model for hardware frameworks, wherein the class model is configured to categorize hardware frameworks by their primary application into one of the following classes:
a. prototype hardware framework class; and
b. production hardware framework class.

5. The system architecture of claim 4, wherein the production hardware framework class is physically implemented by a production hardware framework apparatus.

6. An object-oriented method of designing embedded systems based on a system architecture wherein hardware objects are integrated with a hardware framework, the method comprising:
a. selecting existing and defining new hardware objects which together constitute embedded system hardware;
b. designing and developing the new hardware objects in accordance with a hardware object class definition;
c. integrating the hardware objects with a prototyping hardware framework to build a hardware prototype;
d. integrating the hardware objects with a production hardware framework to generate a production-grade hardware design; and
e. configuring and integrating software objects associated with their respective hardware counterparts into the embedded application.

7. The method of claim 6, wherein configuring and integrating software objects is performed with a Graphical User Interface (GUI).

8. The method of claim 7, wherein the GUI uses a software class hierarchy as an abstraction model for the hardware objects.

9. A software architecture for device drivers, comprising:
a. a plurality of software objects corresponding to an abstraction for each hardware object;
b. an array of data objects corresponding respectively to each of the software objects;
c. a device driver table having an entry for each of the software objects; and
d. a callback function associated with each of the software objects.

10. The software architecture of claim 9, wherein the callback functions enable the software objects to notify application software of relevant events related to the operation of their corresponding hardware objects.
